(19) United States
(12) Patent Application Publication
(10) Pub. No.: US 2026/0013015 A1
(43) Pub. Date: Jan. 8, 2026

(54) EXPLOSION-PROOF LUMINAIRE WITH COLOR-TEMPERATURE ADJUSTMENT FUNCTION

(71) Applicant: Dong Guan Pan American Electronics CO., Ltd, Dongguan (CN)

(72) Inventors: Xiaoyun ZENG, Dongguan (CN); Jun ZENG, Dongguan (CN)

(21) Appl. No.: 19/327,972

(22) Filed: Sep. 12, 2025

(30) Foreign Application Priority Data
Jul. 31, 2025 (CN) 202521624515.9

(51) Int. Cl. H05B 45/20; F21V 23/00; F21V 23/04; F21V 25/12; F21V 31/00; F21Y 113/13; F21Y 115/10; H05B 45/10; H05B 45/325; H05B 45/345; H05B 47/155

(52) U.S. Cl. CPC H05B 45/20; F21V 23/009; F21V 23/04; F21V 25/12; F21V 31/005; H05B 45/325; H05B 45/345; H05B 47/155; F21Y 2113/13; F21Y 2115/10; H05B 45/10

(57) ABSTRACT

An explosion-proof luminaire with a color-temperature-adjustment function, including a housing, a dual-color-temperature LED panel, and a control circuit including an LED driver and a color-temperature control unit. The LED panel includes a first LED array and a second LED array varying in color temperature, which are controlled by the control circuit. Input and output ends of the LED panel are respectively connected to an output end of the LED driver and an input end of the control unit. The control unit includes a color-temperature DIP adjustment subunit, a color-temperature safe barrier control subunit, a voltage sampling subunit, a power supply control subunit, a central control subunit, a shunt control subunit and an interface subunit. The shunt control subunit is controlled by the central control subunit based on sampled voltage of the voltage sampling subunit, controlling circuit switching (on/off) of the first and second LED arrays.

### CROSS-REFERENCE TO RELATED APPLICATIONS

This application claims the benefit of priority from Chinese Patent Application No. 202521624515.9, field on Jul. 31, 2025. The content of the aforementioned application, including any intervening amendments thereto, is incorporated by reference in its entirety.

### TECHNICAL FIELD

This application relates to lighting facilities, and more particularly to an explosion-proof luminaire with a color-temperature adjustment function.

### BACKGROUND

With the increasing maturity and stability of light-emitting diode (LED) technology, LED luminaires have been widely adopted in various human activities. As an LED luminaire, the explosion-proof luminaire is specifically designed for hazardous environments with high fire and explosion risks, which is capable of preventing internal electrical sparks or high temperatures from igniting combustible gases, dust, or vapors in the surrounding atmosphere.

However, the existing explosion-proof luminaires struggle with the following drawbacks during the use and producing process.
(1) Ordinary explosion-proof luminaires can only be manufactured with a single fixed color temperature (e.g., 4,000 K). If a luminaire with a color-temperature power of 6,000 K is found to be desired in the practical use, the user needs to purchase the desired luminaire for replacement, resulting in a waste of cost and time.
(2) The manufactured explosion-proof luminaires are only configured with a single fixed color temperature, such that it is required to manufacture multiple explosion-proof luminaires varying in color temperature to meet diverse users' demand, which may lead to additional inventory buildup and overstocking. This ultimately affecting the manufacturer's product cycle and capital recovery.

### SUMMARY

In view of this, the present disclosure provides an explosion-proof luminaire with a color-temperature adjustment function to solve the problems in the prior art.

An explosion-proof luminaire with a color-temperature adjustment function, comprising:
a housing;
a dual-color-temperature light emitting diode (LED) panel; and
a control circuit;
wherein the dual-color-temperature LED panel is provided with a first LED array and a second LED array; a color temperature of the first LED array is higher than that of the second LED array;
the control circuit is configured to control operation of the first LED array and second LED array, and the control circuit comprises an LED driver and a color-temperature control unit;
an input end of the dual-color-temperature LED panel is connected to an output end of the LED driver; and an output end of the dual-color-temperature LED panel is connected to an input end of the color-temperature control unit;
the color-temperature control unit comprises a color-temperature dual in-line package switch (DIP) adjustment subunit, a color-temperature safe barrier control subunit, a voltage sampling subunit, a power supply control subunit, a central control subunit, a shunt control subunit and an interface subunit;
the LED driver is connected to an input end of the power supply control unit, an input end of the first LED array, and an input end of the second LED array;
the shunt control subunit is connected to an output end of the first LED array and an output end of the second LED array; and
a current stabilized by the power supply control subunit is configured to flow through the color-temperature DIP adjustment subunit, the color-temperature safe barrier control subunit and the voltage sampling subunit; and the central control subunit is configured to control operation of the shunt control subunit based on a sampled voltage from the voltage sampling subunit.

In an embodiment, the explosion-proof luminaire further comprising:
a sealing member;
wherein the dual-color-temperature LED panel and the control circuit are arranged in the housing; the housing is provided with a positioning hole; and the sealing member is arranged at the housing, and is configured to seal the positioning hole.

In an embodiment, the color-temperature DIP adjustment subunit comprises a DIP switch; and the DIP switch is arranged at an inner side of the housing, and is arranged opposite to the sealing member in a vertical direction.

In an embodiment, the sealing member is a plug or a cover.

In an embodiment, the color-temperature DIP adjustment subunit further comprises a plurality of voltage-adjusting resistors; and first DIP switch is configured to perform state switch to connect one or more of the plurality of voltage-adjusting resistors into a circuit of the color-temperature DIP adjustment subunit for voltage division.

In an embodiment, the control circuit further comprises a silicone potting layer on the color-temperature control unit, wherein the silicone potting layer is configured to sealedly encapsulate the color-temperature safe barrier control subunit, the voltage sampling subunit, the power supply control subunit, the central control subunit and the shunt control subunit; and the color-temperature DIP adjustment subunit and the interface subunit are configured to be exposed outside the silicone potting layer.

In an embodiment, the power supply control subunit is provided with a voltage regulator and a first fuse; and a main circuit of the color-temperature safe barrier control subunit is provided with a second fuse and a current-limiting resistor;
two ends of the main circuit of the color-temperature safe barrier control subunit are connected to the voltage sampling subunit and the color-temperature DIP adjustment subunit, respectively; and
the color-temperature safe barrier control subunit is provided with a Zener diode; and a first end of the Zener diode is connected in parallel to a circuit between the main circuit of the color-temperature safe barrier control subunit and the color-temperature DIP adjustment subunit, while a second end of the Zener diode is grounded.

In an embodiment, the central control subunit is provided with a control chip, wherein the control chip is provided with an analog-to-digital (A/D) port, a pulse width modulation 1 (PWM1) port and a pulse width modulation 2 (PWM2) port; and the control chip is configured to detect a sampled voltage of the voltage sampling subunit via the A/D port;
the shunt control subunit further comprises a first shunt circuit and a second shunt circuit; the first shunt circuit is provided with a first p-channel metal-oxide-semiconductor (PMOS) transistor, and a drain of the first PMOS transistor is connected to the output end of the first LED array; a source of the first PMOS transistor is grounded; and a gate of the first PMOS transistor is connected to the PWM1 port of the control chip via a first resistor; and
the second shunt circuit is provided with a second PMOS transistor; a drain of the second PMOS transistor is connected to the output end of the second LED array; a source of the second PMOS transistor is grounded; and a gate of the second PMOS transistor is connected to the PWM2 port of the control chip via a second resistor.

In an embodiment, the control circuit further comprises a power control unit; the power control unit is configured to regulate an output power of the LED driver, and the power control unit comprises a power DIP adjustment subunit and a power safe barrier control subunit;
a main circuit of the power safe barrier control subunit is provided with a fuse and a current-limiting resistor;
the color-temperature safe barrier control subunit is provided with a Zener diode; and a first end of the Zener diode is connected in parallel to a circuit between the main circuit of the power safe barrier control subunit and the power DIP adjustment subunit, and a second end of the Zener diode is grounded; and
the control circuit further comprises a silicone potting layer on the power control unit; the silicone potting layer is configured to sealedly encapsulate the power safe barrier control subunit; and the power DIP adjustment subunit and the interface subunit are configured to be exposed outside the silicone potting layer.

In an embodiment, the power DIP adjustment subunit further comprises a DIP switch and a plurality of voltage-adjusting resistors; the DIP switch is configured to perform state switch to connect one or more of the plurality of voltage-adjusting resistors into a circuit of the power DIP adjustment subunit for voltage division; and the DIP switch is arranged at an inner side of the housing, and is arranged opposite to the sealing member in a vertical direction.

Compared to the prior art, the present disclosure has the following beneficial effects.

The explosion-proof luminaire provided herein includes a color-temperature control unit and a dual-color-temperature LED panel with a first LED array with a high color temperature and a second LED array with a low color temperature. The color-temperature control unit includes a color-temperature DIP adjustment subunit, a color-temperature safe barrier control subunit, a voltage sampling subunit, a power supply control subunit, a central control subunit, a shunt control subunit and an interface subunit. The central control subunit is configured to control operation of the shunt control subunit based on a sampled voltage from the voltage sampling subunit, thereby controlling circuit switching (on/off) of the first array and the second LED array to allow the dual-color-temperature LED panel to operate in one of the three states: high color temperature, intermediate color temperature, and low color temperature. Consequently, the users can adjust the color temperature according to their specific requirements, resulting in high flexibility and strong applicability.

### BRIEF DESCRIPTION OF THE DRAWINGS

FIG. 1 schematically shows connection of various modules according to an embodiment of the present disclosure;

FIG. 2 is an application block diagram according to an embodiment of the present disclosure;

FIG. 3 schematically shows an opening process of a sealing member, where the sealing member is a plug;

FIG. 4 schematically shows an opening process of the sealing member, where the sealing member is a cover;

FIG. 5 schematically shows connection of modules in a power adjustment control unit and modules in a color-temperature control unit according to an embodiment of the present disclosure;

FIG. 6 is a circuit diagram of the color-temperature control unit according to an embodiment of the present disclosure; and

FIG. 7 is a circuit diagram of the power adjustment control unit according to an embodiment of the present disclosure.

### DETAILED DESCRIPTION OF EMBODIMENTS

To make the objects, features and advantages of the present disclosure clearer, the embodiments of the present disclosure will be described below in combination with the accompanying drawings. Many specific details are provided below to facilitate understanding the present disclosure. Obviously, described below are merely some embodiments of the present disclosure, not all embodiments. The present disclosure can be implemented in many other ways different from those described herein. Similar improvements can be made by those of ordinary skill in the art without departing from the spirit of the present disclosure. Therefore, the embodiments described below are not intended to limit this present disclosure.

As used herein, it should be understood that orientation or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, and “circumferential” are based on the orientations or positional relationships shown in the accompanying drawings. These terms are merely for the purpose of facilitating and simplifying the description, rather than indicating or implying that the devices or components referred to must have a specific orientation, or be constructed and operated in the specific orientation. Therefore, the terms cannot be understood as limitations of the present disclosure.

Furthermore, the terms “first” and “second” are only for descriptive purposes, and should not be understood as indicating or implying the relative importance or the quantity of the technical features involved. Therefore, features defined by “first” or “second” may explicitly or implicitly indicate the inclusion of at least one of such features. In the description of the present disclosure, unless otherwise stated, “a plurality of” means at least two, such as two, three, and so on.

As used herein, it should be noted that unless otherwise specified, the terms “arrangement”, “connection”, “attachment” and “fix” should be broadly interpreted. For example, it can be a fixed connection, a detachable connection or an integrated connection; it may be a mechanical connection or an electrical connection; it can be a direct connection, an indirect connection through an intermediate medium, or an internal communication between two components. For those skilled in the art, the specific meanings of the above terms in this disclosure can be understood according to the context.

As used herein, it should be noted that unless otherwise specified, the description of a first feature being “on” or “under” a second feature can be a direct connection between the first feature and the second feature, or an indirect connection through an intermediate medium between the first feature and the second feature. Moreover, the first feature being “above”, “over” or “on a top of” the second feature can indicate that the first feature is directly above, diagonally above, or merely at a higher horizontal level than the second feature. The first feature being “below,” “under,” or “beneath” the second feature can indicate that the first feature is directly below, diagonally below, or merely at a lower horizontal level than the second feature.

It should be noted that a component referred to being “fixed to” or “arranged on” another component, can be a direct arrangement or an intervening arrangement. A component being “connected” to another component can be a direct connection or an intervening connection. The terms such as “vertical”, “horizontal”, “up”, “down”, “left”, “right” and similar expressions used herein are merely for the purpose of illustrating, instead of limiting the disclosure.

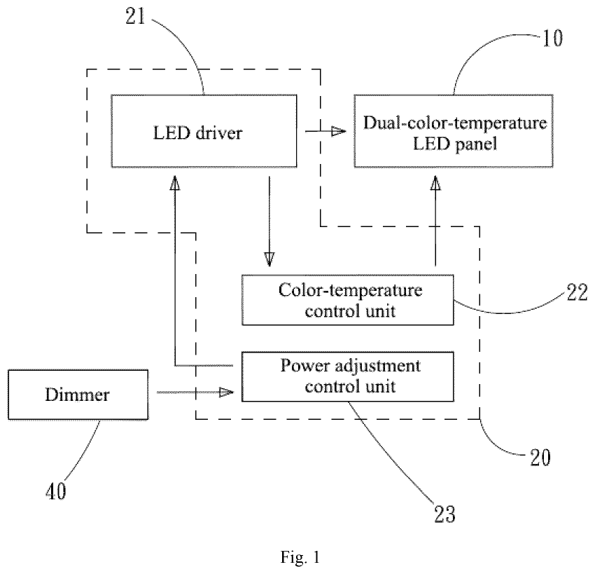

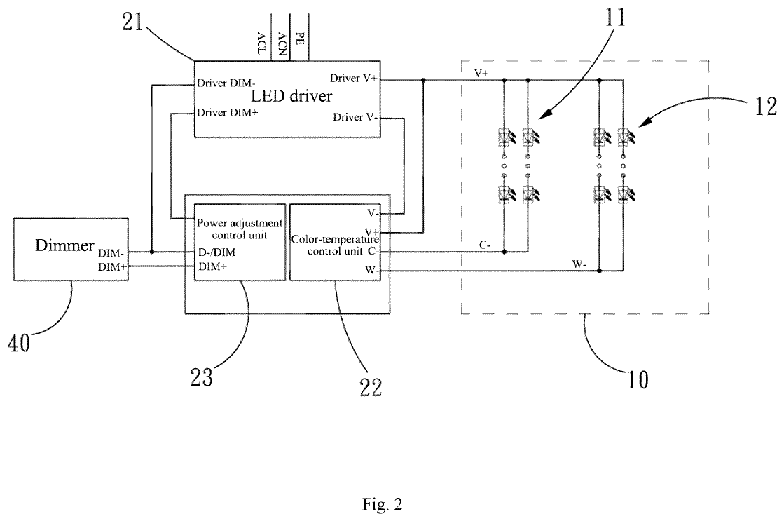

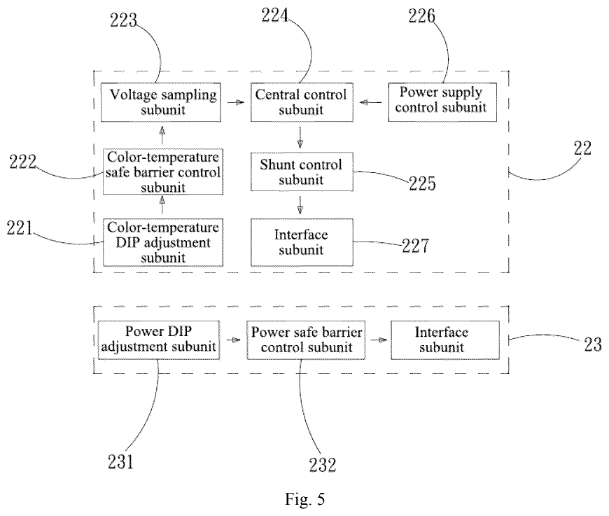

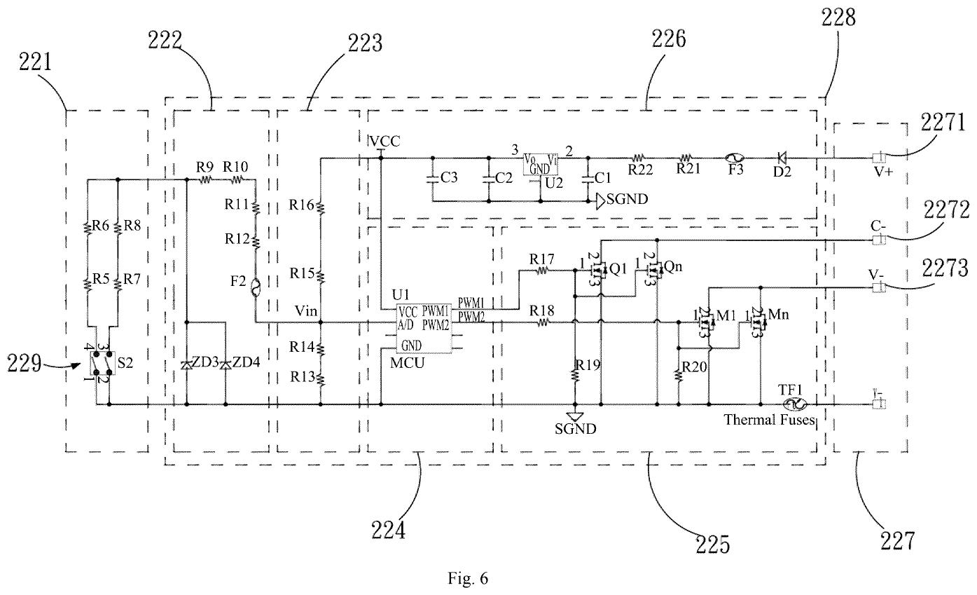

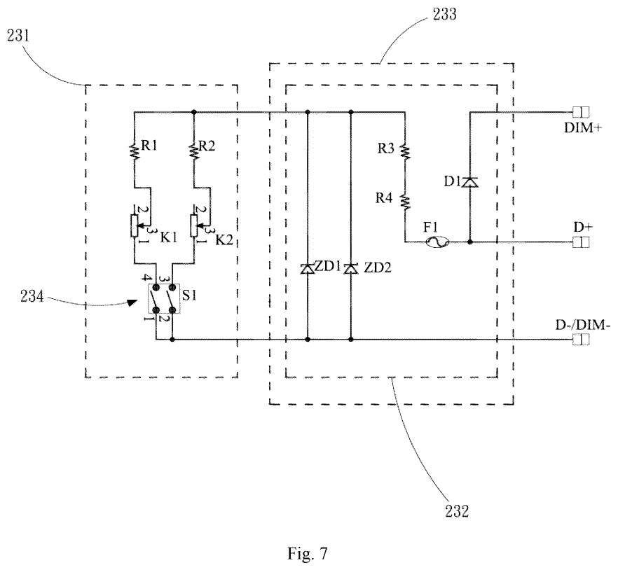

Referring to FIGS. 1-7, the present disclosure provides an explosion-proof luminaire with a color-temperature adjustment function, including a housing 40, a dual-color-temperature light-emitting diode (LED) panel 10, a control circuit 20 and a sealing member 30. The dual-color-temperature LED panel 10 and the control circuit 20 are arranged in the housing 40. The dual-color-temperature LED panel 10 is provided with a first LED array 11 with a high color temperature and a second LED array 12 with a low color temperature. The control circuit 20 is configured to control the operation of the first LED array 11 and the second LED array 12.

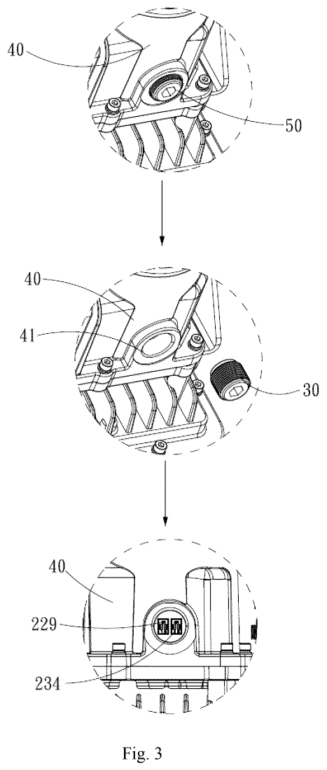

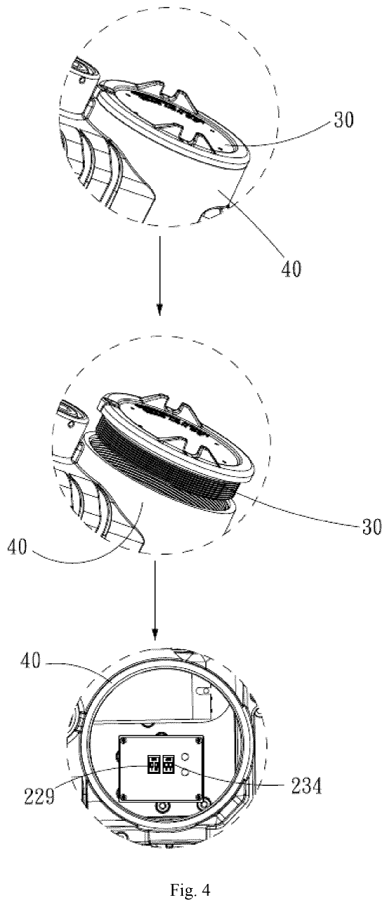

The housing 40 is provided with a positioning hole 41, and the sealing member 30 is arranged on the housing 40, and is configured to seal the positioning hole 41. In this embodiment, an internal thread is provided on a wall of the positioning hole 41, and an external thread is provided on a peripheral surface of the sealing member 30. A threaded assembly is adopted for the sealing member 30 and the positioning hole 41. Moreover, the sealing member 30 can be a plug (as shown in FIG. 3) or a cover (as shown in FIG. 4).

The control circuit 20 includes an LED driver 21, a power control unit 23 and a color-temperature control unit 22. The LED driver 21 is electrically connected to the power control unit 23 and the color-temperature control unit 22. The power control unit 23 is configured to regulate an output power of the LED driver 21. The LED driver 21 is configured to supply power to the color-temperature control unit 22 and the dual-color-temperature LED panel 10. An input end of the dual-color-temperature LED panel 10 is connected to an output end of the LED driver 21, and an output end of the dual-color-temperature LED panel 10 is connected to an input end of the color-temperature control unit 22. The color-temperature control unit 22 is configured to control circuit switching (on/off) of the first array 11 and the second LED array 12, thereby achieving the color-temperature adjustment.

The color-temperature control unit 22 includes a color-temperature dual in-line package (DIP) adjustment subunit 221, a color-temperature safe barrier control subunit 222, a voltage sampling subunit 223, a power supply control subunit 226, a central control subunit 224, a shunt control subunit 225 and an interface subunit 227. The LED driver 21 is connected to an input end of the power supply control subunit 226, an input end of the first LED array 11, and an input end of the second LED array 12. The shunt control subunit 225 is connected to an output end of the first LED array 11 and an output end of the second LED array 12.

A current stabilized by the power supply control subunit 226 is configure to flow through the color-temperature DIP adjustment subunit 221, the color-temperature safe barrier control subunit 222 and the voltage sampling subunit 223. The central control subunit 224 is configured to control operation of the shunt control subunit 225 based on a sampled voltage from the voltage sampling subunit 223, thereby controlling circuit switching (on/off) of the first array 11 and the second LED array 12 to allow the dual-color-temperature LED panel 10 to operate in one of the three states: high color temperature, intermediate color temperature, and low color temperature.

In some embodiments, the interface subunit 227 includes a first port 2271, a second port 2272 and a third port 2273, where the first port 2271 is connected to an input end of the LED driver 21, the second port 2272 is connected to an output end of the first LED array 11, and the third port 2273 is connected to the output end of the second LED array 12.

The power supply control subunit 226 is connected to the first port 2271 of the interface subunit 227. The power supply control subunit 226 is provided with a voltage regulator U2 and a fuse F3, in which the voltage regulator U2 is configured to regulate a current flowing from the power supply control subunit 226. When the current passing through the power supply control subunit 226 is excessive, the temperature of the fuse F3 will rise, thereby causing the first fuse F3 to break the circuit.

The central control subunit 224 is provided with a control chip U1, which is provided with an analog-to-digital port (A/D), a pulse width modulation 1 (PWM1) port, a pulse width modulation 2 (PWM2) port and a voltage common collector (VCC) port. The VCC port of the control chip U1 is connected to an output end of the power supply control subunit 226, and the LED driver is configured to supply power to the control chip U1 via the power supply control subunit 226.

An input end of the voltage sampling subunit 223 is connected to the output end of the power supply control subunit 226, and an output end of the voltage sampling subunit 223 is grounded. The voltage sampling subunit 223 is provided with a sampling point Vin. A sampling resistor R14 and a sampling resistor R15 are arranged between the sampling point Vin and the voltage sampling subunit 223.

A main circuit of the color-temperature safe barrier control subunit 222 is provided with a fuse F2 and a current-limiting resistor R9. Two ends of the color-temperature safe barrier control subunit 222 are connected to the sampling point Vin of the voltage sampling subunit 223 and the color-temperature DIP adjustment subunit 221, respectively. The color-temperature safe barrier control subunit 222 is further provided with a Zener diode ZD3. A first end of the Zener diode ZD3 is connected in parallel to a circuit between the main circuit of the color-temperature safe barrier control subunit 222 and the color-temperature DIP adjustment subunit 221, and a second end of the Zener diode ZD3 is grounded.

The color-temperature DIP adjustment subunit 221 further includes a first DIP switch 229 and a plurality of voltage-adjusting resistors. The first DIP switch 229 is configured to perform state switch to connect one or more of the plurality of voltage-adjusting resistors into a circuit of the color-temperature DIP adjustment subunit 221 for voltage division.

In an embodiment, the plurality of voltage-adjusting resistors includes a first voltage-adjusting resistor and a second voltage-adjusting resistor, in which a resistor R5 and a resistor R6 are connected in series to form the first voltage-adjusting resistor, and a resistor R7 and a resistor R8 are connected in series to form the second voltage-adjusting resistor. The first DIP switch 229 is configured to perform switching among a first state, a second state and a third state. When the first DIP switch 229 is switched to the first state, the first voltage-adjusting resistor formed by the resistor R5 and the resistor R6 connected in series is connected to the circuit, and the second voltage-adjusting resistor formed by the resistor R7 and the resistor R8 connected in series is in an off position. When the first DIP switch 229 is switched to the second state, the first voltage-adjusting resistor formed by the resistor R5 and the resistor R6 connected in series is in the off position, and the second voltage-adjusting resistor formed by the resistor R7 and the resistor R8 connected in series is connected to the circuit. When the first DIP switch 229 is switched to the third state, the first and second voltage-adjusting resistors are both connected to the circuit.

The shunt control subunit 225 further includes a first shunt circuit and a second shunt circuit. The first shunt circuit is provided with a positive channel metal-oxide-semiconductor (PMOS) transistor Q1. A drain of the PMOS transistor Q1 is connected to the output end of the first LED array 11. A source of the PMOS transistor Q1 is grounded. A gate of the PMOS transistor Q1 is connected to a pulse width modulation 1 (PWM1) port of the control chip U1 via a resistor R17. The second shunt circuit is provided with a PMOS transistor M1. A drain of the PMOS transistor M1 is connected to the output end of the second LED array 12. A source of the PMOS transistor M1 is grounded. A gate of the PMOS transistor M1 is connected to a pulse width modulation 2 (PWM2) port of the control chip U1 via a resistor R18.

In the working process, the state of the first DIP switch 229 is adjusted to connect one or more of the plurality of voltage-adjusting resistors into a circuit of the color-temperature DIP adjustment subunit 221 for voltage division, so as to adjust a voltage at the sampling point Vin of the voltage sampling subunit 223. The control chip U1 is configured to detect the voltage of the sampling point Vin via the A/D port, and control a voltage of the PWM1 port and a voltage of the PWM2 port based on the voltage of the sampling point Vin, thereby controlling a circuit switching (on/off) of the PMOS transistor Q1 and the PMOS transistor M1, and allowing one or both of the first LED array 11 and the second LED array 12 to be in an on state.
(1) When Vin>Va, the PWM1 port continuously outputs a high level, and in this case, the PMOS transistor Q1 is electrically connected, and the first LED array 11 is in an on state; the PWM2 port continuously outputs a low level, and in this case, the PMOS transistor M1 is cut off, and the second LED array 12 is in an off state; and the dual-color-temperature LED panel 10 exhibits a high color temperature state.
(2) When (Vb+Vth)<Vin<(Va−Vth), both PWM1 and PWM2 ports continuously output a high level, and in this case, the and PMOS transistors Q1 and M1 are electrically connected, and both the first LED array 11 and the second LED array 12 are in the on state; and the dual-color-temperature LED panel 10 exhibits an intermediate color temperature state.
(3) When Vin<Vb, the PWM1 port continuously outputs a low level, and in this case, the PMOS transistor Q1 is cut off and the first LED array 11 is in the off state; the PWM2 port continuously outputs a high level, and in this case the PMOS transistor MI is electrically connected, and the second LED array 12 is in the on state; and the dual-color-temperature LED panel 10 overall exhibits a low color temperature state.

Vin represents the sampled voltage of the sampling point Vin, and the voltages of Va, Vb, and Vth are set based on practical requirements, where Va>Vb and (Va−Vb)>Vth×2; it is recommended that Vth is set greater than 0.3 V; and Vth is a hysteresis voltage value established through an inherent tolerance of an electronic component to prevent circuit malfunctions and ensure accurate and interference-free state switch.

In some embodiments, the control circuit 20 further comprises a silicone potting layer 228 on the color-temperature control unit 22, and the silicone potting layer 228 is configured to sealedly encapsulate the color-temperature safe barrier control subunit 222, the voltage sampling subunit 223, the power supply control subunit 226, the central control subunit 224 and the shunt control subunit 225. The color-temperature DIP adjustment subunit 221 and the interface subunit 227 are configured to be exposed outside the silicone potting layer 228, thereby effectively preventing the color-temperature safe barrier control subunit 222, the voltage sampling subunit 223, the power supply control subunit 226, the central control subunit 224 and the shunt control subunit 225 from producing sparks and installation hazards in the working process. In the color-temperature DIP adjustment subunit 221, voltage and current limitation are achieved via a Zener diode ZD3, a current-limiting resistor R9 and a fuse F2, thereby effectively preventing the color-temperature DIP adjustment subunit 221 from producing sparks, and safeguarding the DIP adjustment circuit. In this embodiment, in order to facilitate the adjustment, the first DIP switch 229 is arranged at an inner side of the housing 40, and is arranged opposite to the sealing member 30 in a vertical direction.

In an embodiment, the explosion-proof luminaire further includes a dimmer 50. An external power supply is connected to the power control unit 23 via the dimmer 50. By arranging the power control unit 23 in the circuit, and providing the power control unit 23 with a second DIP switch 234, users can toggle the switch to a corresponding gear based on required LED luminaire power for the application scenario. If the gear is electrically conducted, a current loop is formed via the gear and other components, thereby changing a voltage of a Driver DIM+ end of a dimming port on the LED driver 21 and a voltage of a Driver DIM− end of the dimming port on the LED driver 21, changing an output current of the LED driver 21 and adjusting the LED luminaire power.

In some embodiments, the power control unit 23 includes the power DIP adjustment unit 231 and the power safe barrier control subunit 232. The main circuit of the power safe barrier control subunit 232 is provided with a fuse F1 and a current-limiting resistor R3. The color-temperature safe barrier control subunit 222 is provided with a Zener diode ZD1. A first end of the Zener diode ZD1 is connected in parallel to a circuit between the main circuit of the power safe barrier control subunit 232 and the power DIP adjustment subunit 231, and a second end of the Zener diode ZD1 is grounded.

The power DIP adjustment subunit 231 includes the second DIP switch 234 and a plurality of voltage-adjusting resistors. The DIP-switch 234 is configured to perform state switch to connect one or more of the plurality of voltage-adjusting resistors into the circuit of the power DIP adjustment subunit 231 for voltage division.

In an embodiment, the control circuit 20 includes a silicone potting layer 233 on the power control unit 23, in which the silicone potting layer 233 is configured to sealedly encapsulate the power safe barrier control subunit 232. The power DIP adjustment subunit 231 and the interface subunit 227 are configured to be exposed outside the silicone potting layer, thereby effectively preventing the power safe barrier control subunit 232 from producing sparks and installation hazards in the working process. In the power DIP adjustment subunit 231, voltage and current limitation are achieved via a Zener diode ZD1, a current-limiting resistor R3 and a fuse F1, thereby preventing the color-temperature DIP adjustment subunit 221 from producing sparks.

In this embodiment, in order to facilitate adjusting the second DIP switch 234, the second DIP switch 234 is arranged at the inner side of the housing 40, and is arranged opposite to the sealing member 30 in a vertical direction.

In this embodiment, opening a circular cover of the sealing member 30 (as shown in FIG. 4) is configured to wire and adjust the color-temperature and power by toggling the first DIP switch 229 and the second DIP switch 234. There is no need to open the power supply box, meaning screws of the power supply box do not require loosening, saving time for operations such as wiring.

The beneficial effects of the explosion-proof luminaire provided in the present disclosure are described as follows.

By arranging the color-temperature control unit 22 and providing the dual-color-temperature LED panel 10 with the first LED array 11 and the second LED array 12, the color-temperature control unit 22 further includes the color-temperature DIP adjustment subunit 221, the color-temperature safe barrier control subunit 222, the voltage sampling subunit 223, the power supply control subunit 226, the central control subunit 224, the shunt control subunit 225 and the interface subunit 226.

The central control subunit 224 is configured to control the operation of the shunt control subunit 225 based on the sampled voltage from the voltage sampling subunit 223, controlling a circuit switching (on/off) of the first array 11 and the array 12 to allow the dual-color-temperature LED panel 10 to operate in one of the three states: high color temperature, intermediate color temperature, or low color temperature. Consequently, the users can adjust the color temperature according to their specific requirements, resulting in high flexibility and strong applicability.

The technical features of the embodiments described above could be combined. For the sake of brevity, not all possible combinations of the technical features in the above embodiments have been described herein. However, any combination of the technical features shall be considered within the scope of the disclosure as long as there is no contradiction.

Described above are merely some embodiments of the present disclosure, and the description thereof is relatively specific and detailed. Nevertheless, it should be understood that the embodiments described above are not intended to limit the present disclosure. It should be noted that various modifications and improvements made by those of ordinary skill in the art without departing from the spirit of the present disclosure shall fall within the scope of the present disclosure defined by the appended claims.

What is claimed is:

1. An explosion-proof luminaire with a color-temperature adjustment function, comprising:
a housing;
a dual-color-temperature light emitting diode (LED) panel; and
a control circuit;
wherein the dual-color-temperature LED panel is provided with a first LED array and a second LED array; a color temperature of the first LED array is higher than that of the second LED array;
the control circuit is configured to control operation of the first LED array and the second LED array, and the control circuit comprises an LED driver and a color-temperature control unit;
an input end of the dual-color-temperature LED panel is connected to an output end of the LED driver; and an output end of the dual-color-temperature LED panel is connected to an input end of the color-temperature control unit;
the color-temperature control unit comprises a color-temperature dual in-line package (DIP) adjustment subunit, a color-temperature safe barrier control subunit, a voltage sampling subunit, a power supply control subunit, a central control subunit, a shunt control subunit and an interface subunit;
the LED driver is connected to an input end of the power supply control subunit, an input end of the first LED array and an input end of the second LED array;
the shunt control subunit is connected to an output end of the first LED array and an output end of the second LED array; and
a current stabilized by the power supply control subunit is configured to flow through the color-temperature DIP adjustment subunit, the color-temperature safe barrier control subunit and the voltage sampling subunit; and the central control subunit is configured to control operation of the shunt control subunit based on a sampled voltage from the voltage sampling subunit.

2. The explosion-proof luminaire according to claim 1, further comprising:
a sealing member;
wherein the dual-color-temperature LED panel and the control circuit are arranged in the housing; the housing is provided with a positioning hole; and the sealing member is arranged at the housing, and is configured to seal the positioning hole.

3. The explosion-proof luminaire according to claim 2, wherein the color-temperature DIP adjustment subunit comprises a DIP switch; and the DIP switch is arranged at an inner side of the housing, and is arranged opposite to the sealing member in a vertical direction.

4. The explosion-proof luminaire according to claim 3, wherein the sealing member is a plug or a cover.

5. The explosion-proof luminaire according to claim 3, wherein the color-temperature DIP adjustment subunit further comprises a plurality of voltage-adjusting resistors; and the DIP switch is configured to perform state switch to connect one or more of the plurality of voltage-adjusting resistors into a circuit of the color-temperature DIP adjustment subunit for voltage division.

6. The explosion-proof luminaire according to claim 1, wherein the control circuit further comprises a silicone potting layer on the color-temperature control unit, and the silicone potting layer is configured to sealedly encapsulate the color-temperature safe barrier control subunit, the voltage sampling subunit, the power supply control subunit, the central control subunit and the shunt control subunit; and the color-temperature DIP adjustment subunit and the interface subunit are configured to be exposed outside the silicone potting layer.

7. The explosion-proof luminaire according to claim 6, wherein the power supply control subunit is provided with a voltage regulator and a first fuse; and a main circuit of the color-temperature safe barrier control subunit is provided with a second fuse and a current-limiting resistor;
two terminals of the main circuit of the color-temperature safe barrier control subunit are connected to the voltage sampling subunit and the color-temperature DIP adjustment subunit, respectively; and
the color-temperature safe barrier control subunit is provided with a Zener diode; and a first end of the Zener diode is connected in parallel to a circuit between the main circuit of the color-temperature safe barrier control subunit and the color-temperature DIP adjustment subunit, and a second end of the Zener diode is grounded.

8. The explosion-proof luminaire according to claim 1, wherein the central control subunit is provided with a control chip, and the control chip is provided with an analog-to-digital (A/D) port, a pulse width modulation 1 (PWM1) port and a PWM2 port; and the control chip is configured to detect a sampled voltage of the voltage sampling subunit via the A/D port;
the shunt control subunit comprises a first shunt circuit and a second shunt circuit; the first shunt circuit is provided with a first positive channel metal-oxide-semiconductor (PMOS) transistor; a drain of the first PMOS transistor is connected to the output end of the first LED array; a source of the first PMOS transistor is grounded; and a gate of the first PMOS transistor is connected to the PWM1 port of the control chip via a first resistor; and
the second shunt circuit is provided with a second PMOS transistor; a drain of the second PMOS transistor is connected to the output end of the second LED array; a source of the second PMOS transistor is grounded; and a gate of the second PMOS transistor is connected to the PWM2 port of the control chip via a second resistor.

9. The explosion-proof luminaire according to claim 2, wherein the control circuit further comprises a power control unit; the power control unit is configured to regulate an output power of the LED driver; and the power control unit comprises a power DIP adjustment subunit and a power safe barrier control subunit;
a main circuit of the power safe barrier control subunit is provided with a fuse and a current-limiting resistor; and
the color-temperature safe barrier control subunit is provided with a Zener diode; and a first end of the Zener diode is connected in parallel to a circuit between the main circuit of the power safe barrier control subunit and the power DIP adjustment subunit, and a second end of the Zener diode is grounded.

10. The explosion-proof luminaire according to claim 9, wherein the control circuit further comprises a silicone potting layer on the power control unit; the silicone potting layer is configured to sealedly encapsulate the power safe barrier control subunit; and the power DIP adjustment subunit and the interface subunit are exposed outside the silicone potting layer.

11. The explosion-proof luminaire according to claim 9, wherein the power DIP adjustment subunit comprises a DIP switch and a plurality of voltage-adjusting resistors; and the DIP switch is configured to perform state switch to connect one or more of the plurality of voltage-adjusting resistors into a circuit of the power DIP adjustment subunit for voltage division.

12. The explosion-proof luminaire according to claim 11, wherein the DIP switch is arranged at an inner side of the housing, and is arranged opposite to the sealing member in a vertical direction.
